(19) United States
(12) Patent Application Publication
(10) Pub. No.: US 2025/0389250 A1
(43) Pub. Date: Dec. 25, 2025

(54) Wind Turbine

(71) Applicant: Andrew Michael Schneider, Greenleaf, WI (US)

(72) Inventor: Andrew Michael Schneider, Greenleaf, WI (US)

(21) Appl. No.: 19/244,526

(22) Filed: Jun. 20, 2025

Related U.S. Application Data
(60) Provisional application No. 63/662,964, filed on Jun. 21, 2024.

(51) Int. Cl. F03D 3/06; F03D 3/00; F03D 7/06

(52) U.S. Cl. CPC F03D 3/067; F03D 3/005; F03D 7/065; F05B 2240/218; F05B 2270/1011

(57) ABSTRACT

A windmill having a vertical wind turbine is provided. The wind turbine has a housing, a frame, a base, an air system and a sail system. The air system has a compressor, a tank, lines, dampeners and regulators. The sail assembly has a positioner comprised of a shaft assembly and two side assemblies. Each side assembly has arms that are movable relative to each other to adjust the pitch of the first sail relative to the second sail. Adjustment can be made by rotating the two ends of the shaft assembly via rotation of a spiral hex shaft within a spiral hex sleeve. The arms move in relation to the turbine rotational speed to adjust the pitch of the sails. The turbine changes to a closed-fault state (no pitch in sails) if there is an air pressure loss in the air system.

### CROSS-REFERENCE TO RELATED APPLICATIONS

This United States utility patent application claims priority on and the benefit of pending provisional application 63/662,964 filed Jun. 21, 2024, the entire contents of which is hereby incorporated herein by reference.

### BACKGROUND OF THE INVENTION

### 1. Field of the Invention

The present invention relates to a wind turbine used in a windmill, and in particular to a wind turbine that has sails that automatically adjust according to wind conditions and that has an incorporated air system.

### 2. Description of the Related Art

Windmills and wind turbines have been in use for many years and there have been many designs. Some designs incorporate fixed positioned sails. Others have pairs of sails connected to a common shaft that change position while the sails rotate about a vertical or horizontal axis.

None of the known windmills and wind turbines have the unique advantages of the present invention.

Thus, there exists a need for a wind turbine that solves these and other problems.

### SUMMARY OF THE INVENTION

A windmill having a vertical wind turbine is provided. The wind turbine has a housing, a frame, a base, an air system and a sail system. The air system has a compressor, a tank, lines, dampeners and regulators. The sail assembly has a positioner comprised of a shaft assembly and two side assemblies. Each side assembly has arms that are movable relative to each other to adjust the pitch of the first sail relative to the second sail. Adjustment can be made by rotating the two ends of the shaft assembly via rotation of a spiral hex shaft within a spiral hex sleeve. The arms move in relation to the turbine rotational speed to adjust the pitch of the sails. The turbine changes to a closed-fault state (no pitch in sails) if there is an air pressure loss in the air system.

There are many aspects of the present invention, which each can have unique and independent advantages, as set out in particular in the appended claims.

According to one advantage of the present invention, each turbine has a pair of sails connected with a shaft assembly. The sails alternate between a thrust position and a rest or closed position. The lower face of a sail is raised in the thrust position to be driven by the wind, and the lower face of a sail is lowered in a rest position. The distal edge of the sail is raised in the thrust position. The distal edge is flat upon the frame in the rest position. The wind automatically causes the sails to rise to the thrust position and fall to the rest position under force of the wind as the sails rotate about a vertical axis. The sails are also located over the sail pivot point.

According to another advantage of the present invention, the relative sail pitch (relative to each other) is variable, and the pitch can depend upon the rotational speed of the turbine. A positioner is provided with a shaft assembly comprising a spiral hex shaft that interacts with a spiral hex sleeve to change the rotational position of the shaft ends relative to each other.

The position of the spiral shaft relative to the spiral hex sleeve is determined by the location of the respective side assembly arms. Each side assembly has an arm with an upper end connected to the shaft assembly with bearing assemblies that are located on opposite sides of the spiral shaft and spiral hex sleeve. As the bearing assemblies are moved closer to and further away from each other, the spiral shaft is moved further into and out of the spiral hex sleeve. This translation causes the ends of the shaft assembly to rotate relative to each other along the shaft axis.

According to a further advantage of the present invention, the top portion of each respective arm moves in the opposite direction of the bottom portion. Hence, as the bottom of the arms separate from each other, the arm tops similarly separate. The opposite is also true, wherein when the tops move towards each other when the arm bottoms move towards each other.

According to a still further advantage of the present invention, a stability bar is provided. The stability bar provides a fixed location relative to the housing for the arms to connect. In some embodiments, the arms are advantageously pivotally connected to the stability bar. In another embodiment, the arms are pivotally connected to each other and to the stability bar at one location.

In one embodiment, sail pitch control is accomplished by having the arms have weights on their lower ends. The weights are on rollers and can roll up base pivot arms as the centrifugal force exceeds the force of gravity on the angled surface. The faster the turbine rotation, the further up the sides the roller weights move. As the weight move up, the top of the arms separate to change the pitch of the sails. If the rotational speed is great enough, the sails close all the way to a closed-speed state. The sails will automatically open back up as the rotational speed of the turbine slows and the weights roll down the pivot arms of the base. Related, the pitch of the pivot arms can be controlled with threaded bolts to finely adjust the arm pitch.

In another embodiment, the movement of the arms is controlled with a counter-rotating gear. The arms each have lower blocks that are threaded onto threaded shaft sections, where rotation of the gear causes the shaft section to rotate in opposite rotational directions so that the respective boxes translate towards or away from each other. Since arms are pivotally connected, the top of the arms separate as the bottom of the arms separate.

This is accomplished in yet another embodiment by having arms with weights at the lower ends of the arms to mechanically govern the speed of the turbine. As the turbine spins the arms swing out to lower the pitch of the sails and therefore reduce turbine rotational speed. In this embodiment, the arms can be pivotally connected to each other.

According to another advantage of the present invention, the turbine can have dampeners that reduce the impact of the sails when moving to the lowered position, as the sails would otherwise abruptly hit the frame. In a preferred embodiment, the dampeners are air bags that are part of the air system. The dampeners are supported by the frame and are located under the lower face of each sail.

According to another advantage of the present invention, the turbine can default to a closed-fault position if there is a loss of air. This advantageously prevents damage to the turbine and sails if the dampeners are inoperable due to air loss. In this regard, the turbine is an automatic shutoff turbine wherein the sails pitch to zero if loss of air. This is accomplished in one embodiment by having air pass through a reversing valve of the base lifts/brake assembly if any air bags lose pressure. If one or more air bags loses pressure, that particular air bag can set the brake while the remaining air bags remain inflated.

In one embodiment, the sails pitch to zero as reversing valve lets air out thereby changes the pitch of the base pivot arms as base lifts deflate to allow the weights to roll out to the outer sides of the base. Related, can start without electricity by allowing weights to move towards center to raise pitch of sails. All that is needed is a source of compressed air to inflate the base lifts so that the roller weights move inwards.

In another embodiment, a brake assembly including a brake, is provided that pushes the arms outward to pitch the sails to zero pitch. This is accomplished as a weight falls in the assembly as air that was suspending the weight via an air ram leaves the system.

In another embodiment, the gear motor can move the sails to their closed positions if there is a default in the air system.

A further advantage of the present invention includes having sails with a face with an integrated flexible member to reduce stress when contact with damper.

According to another advantage of the present invention, when the sails are in the closed position (zero pitch), they are oriented 180 degrees from each other. In the fully open position, the sails are no closer than 95 degrees from each other (ranging between 95 and 180 degrees during operation) to maintain counterbalance so that one sail does not act against the other sail. The air acts on the face of the sail facing the wind over the dampener to drive the turbine.

According to a further advantage of the present invention, air bags of the same shape and location on opposite dampeners can be connected with a shared regulator. In this regard, air can pass between the respective air bags to aid in deflation of an air bag as a sail impacts it.

According to a further advantage of the present invention, successively remote air bags (relative to the shaft assembly) on each dampener may have an increased air pressure. This allows the air bag closest to the shaft assembly to compress easier than the next dampener, to accommodate the impact angle of the sail.

Other advantages, benefits, and features of the present invention will become apparent to those skilled in the art upon reading the detailed description of the invention and studying the drawings.

### BRIEF DESCRIPTION OF DRAWINGS

FIG. 1 is a side view of a windmill having two turbines.

FIG. 2 is an end view of an embodiment of a turbine showing an open state when one sail in a thrust position and the other sail in a rest position.

FIG. 3 is a reverse end view of the turbine shown in FIG. 2.

FIG. 4 is a side view of the turbine shown in FIG. 2, but with the housing removed.

FIG. 5 is a close-up view showing weights in interior positions when the turbine is in the open state.

FIG. 6 is s perspective view of the turbine shown in FIG. 2, but with the sails transitioning between thrust and ret positions.

FIG. 7 is a close-up showing a portion of the position assembly when the turbine is in the open state.

FIG. 8 is similar to FIG. 2 but shows the turbine in an intermediate state.

FIG. 9 is a reverse-end view of the turbine shown in FIG. 8.

FIG. 10 is a side view of the turbine shown in FIG. 8, but with the housing removed.

FIG. 11 is a close up showing a portion of the position assembly when the turbine is in the intermediate state.

FIG. 12 is similar to FIG. 10 but shows the turbine in a closed-speed state.

FIG. 13 is a close-up showing a portion of the position assembly when the turbine is in the closed-speed state.

FIG. 14 is a close-up view showing the weights in a distal positions when the turbine is in the closed-speed state.

FIG. 15 is similar to FIG. 12 but shows the turbine in a closed-fault state.

FIG. 16 is a close-up view showing the weights in a distal positions when the turbine is in the closed-default state.

FIG. 17 is a perspective exploded view of an embodiment of a positioner.

FIG. 18 is a side view of an embodiment of an air system.

FIG. 19 is a perspective view of the air system shown in FIG. 18.

FIG. 20 is a perspective exploded view showing how turbines are connected to a tower.

FIG. 21 is a close-up perspective view of a portion of FIG. 20.

FIG. 22 is an upper perspective view showing the turbine bottom on a turret.

FIG. 23 is a lower perspective view of FIG. 22.

FIG. 24 is a perspective view of an alternative embodiment of a turbine, shown in the open state.

FIG. 25 is similar to FIG. 24 but shows the turbine with the housing removed.

FIG. 26 is a side view of FIG. 25.

FIG. 27 is a close-up view, with beam removed, showing side shafts, a gear motor and a counter-rotating gear box.

FIG. 28 is a close-up view showing the counter-rotating gear box.

FIG. 29 is similar to FIG. 24 but shows the turbine in an intermediate state.

FIG. 30 is a side view of FIG. 29 but shows the turbine with the housing removed.

FIG. 31 is similar to FIG. 29 but shows the turbine in a closed-speed state.

FIG. 32 is a side view of FIG. 31 but shows the turbine with the housing removed.

FIG. 33 is a side view of an embodiment of an air system.

FIG. 34 is a perspective view of the air system shown in FIG. 33.

FIG. 35 is a perspective view of an alternative embodiment of a turbine shown in an open state.

FIG. 36 is similar to FIG. 35 but is shown with the housing removed.

FIG. 37 is an isolation view of the positioner shown in FIG. 36.

FIG. 38 is a close-up side view of a portion of FIG. 36.

FIG. 39 is similar to FIG. 38 but shows the turbine in an intermediate state.

FIG. 40 is similar to FIG. 38 but shows the turbine in a closed-speed state.

FIG. 41 is similar to FIG. 38 but shows the turbine in a closed-fault state.

FIG. 42 is an isolation view of the brake assembly shown when the turbine is in the close-fault state.

FIG. 43 is a perspective view of a windmill showing an alternative sail.

FIG. 44 is a top perspective view of the alternative sail.

FIG. 45 is a lower perspective view of the alternative sail.

FIG. 46 is a flow chart showing the steps of operating a turbine.

### DETAILED DESCRIPTION OF THE INVENTION

While the invention will be described in connection with one or more preferred embodiments, it will be understood that it is not intended to limit the invention to those embodiments. On the contrary, it is intended to cover all alternatives, modifications and equivalents as may be included within the spirit and scope of the invention as defined by the appended claims.

It is appreciated that there are several unique structural features according to various aspects of the present invention. These features can be utilized individually or combined with other features in any possible way, such as being coupled with other features, tripled with other features and/or used all together without departing from the broad aspects of the present invention.

It is further appreciated that there are several unique method features according to the present invention. These features can be utilized individually or combined with other features in any possible way, such as being coupled with other features, tripled with other features and/or used all together without departing from the broad aspects of the present invention.

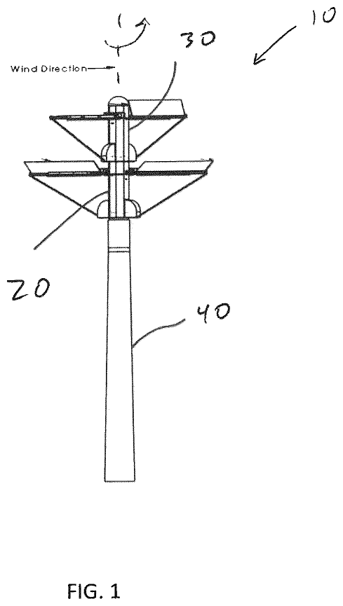

Turning now to FIG. 1, it is seen that an embodiment of a windmill 10 having two vertical turbines 20 and 30 mounted atop a tower 40. The windmill can have any number of turbines vertically stacked on top of each other, respectively. Each turbine is preferably fixed in rotational orientation relative to each other. Turbine 20 is described in detail below. It is preferred that turbine 30 is similar to turbine 20, having a housing, frame, positioner and sails. Preferably, all turbines for a particular windmill share the same compressor and tanks, wherein an air system default defaults all turbines of a particular windmill.

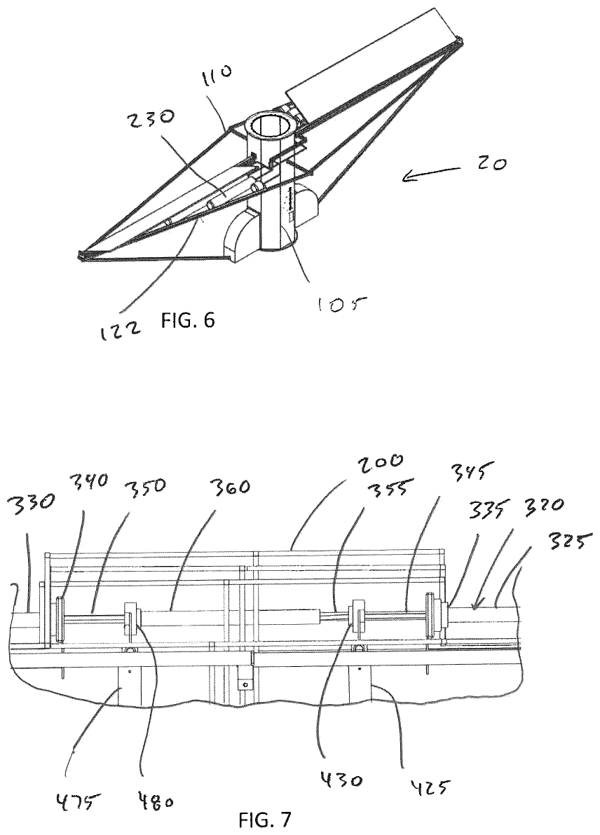

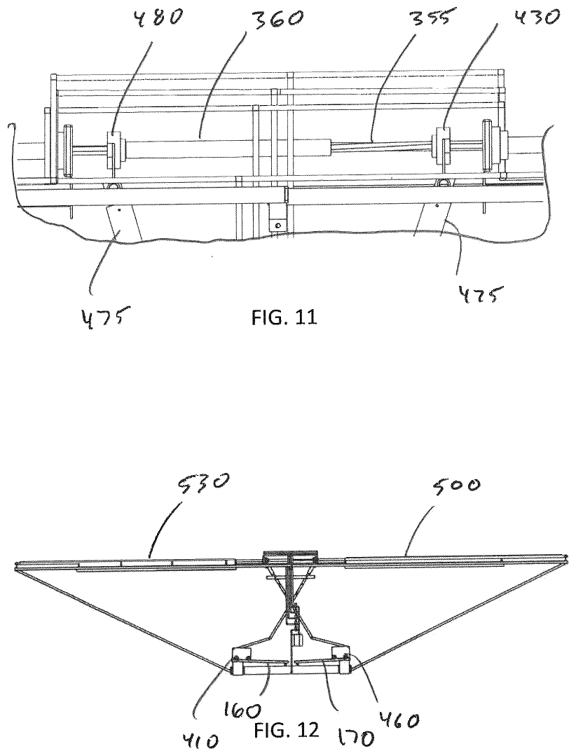

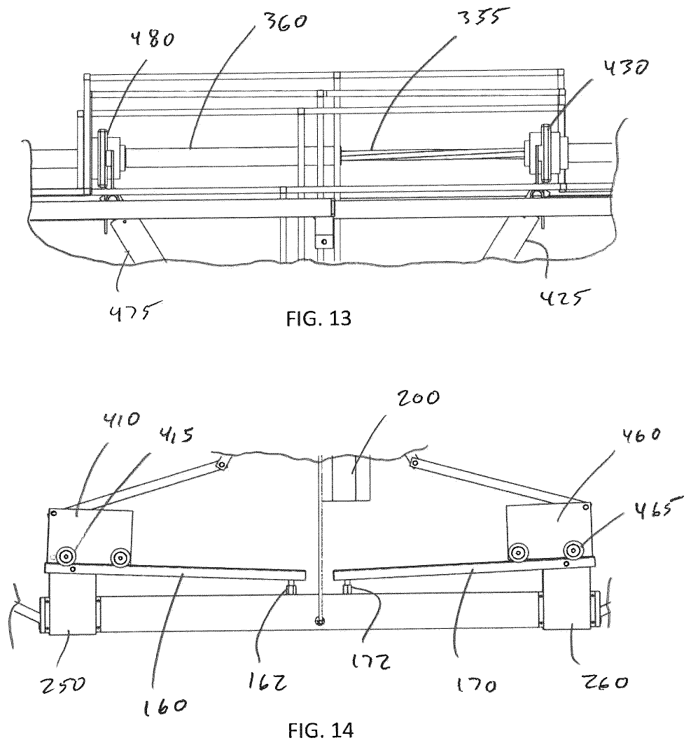

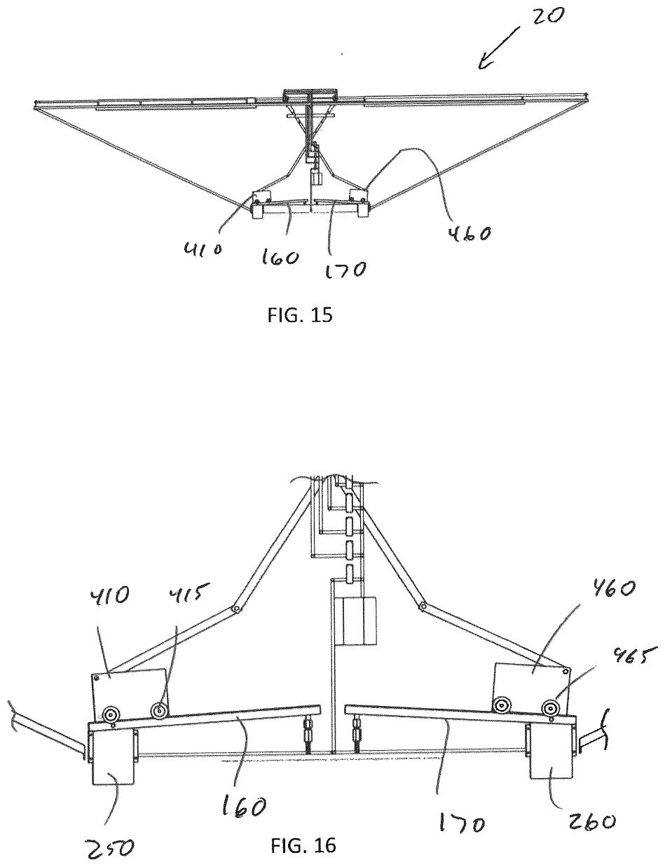

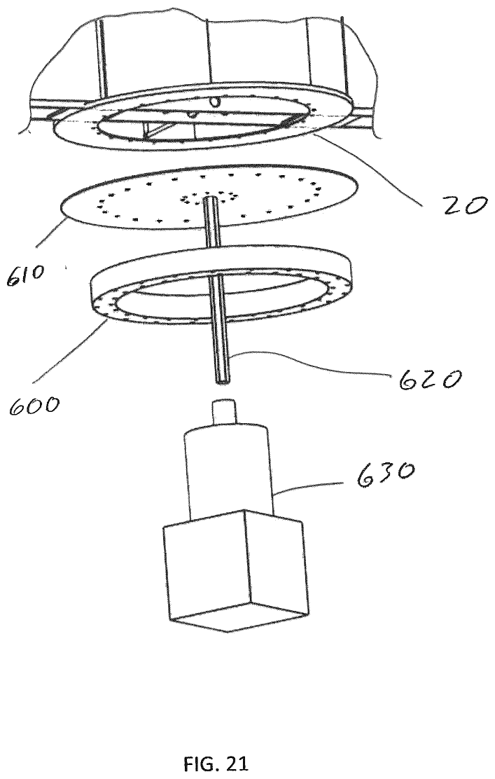

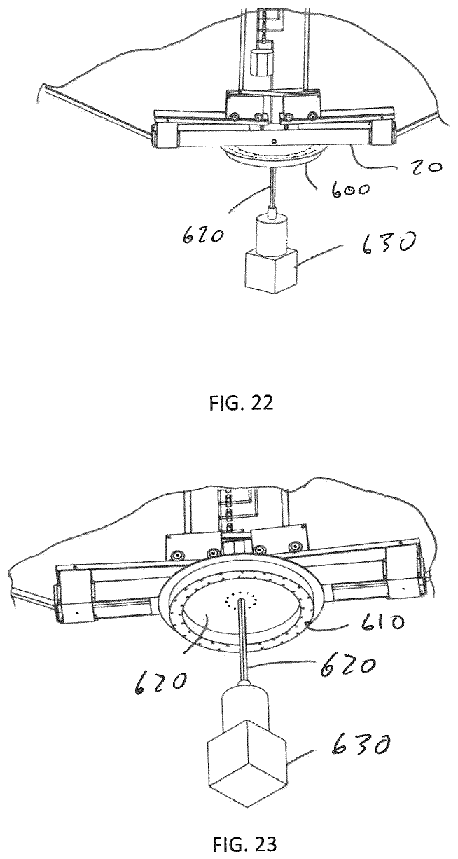

Turbine 20 has a housing 105, a frame 110 with a base 150, an air system 200 and a sail assembly 300. The sail assembly 300 has a positioner 310, a first sail 500 and a second sail 530. Each of these components are described below. The turbine 20 and its various components are illustrated in FIGS. 1-23.

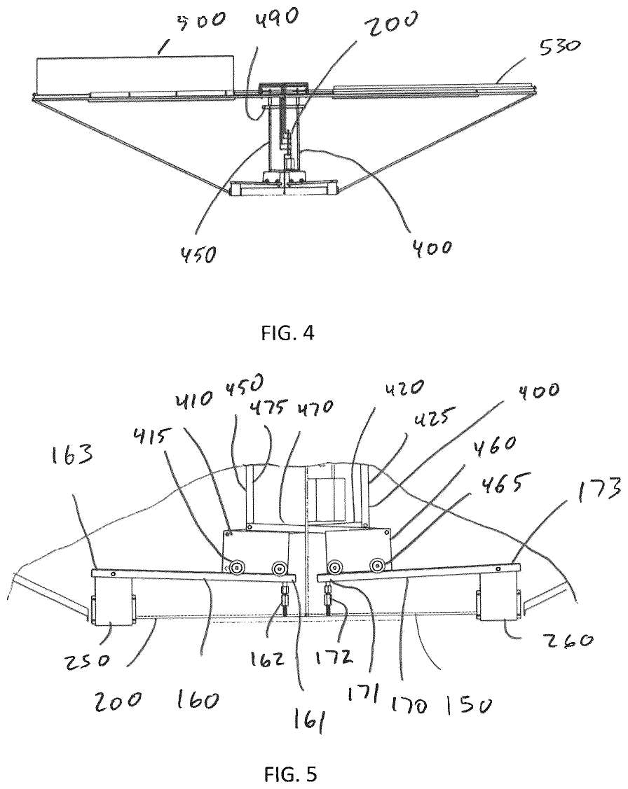

The housing 105 covers the frame 110. As seen in FIG. 4, a stability bar 490 is provided for positioning in the housing 105.

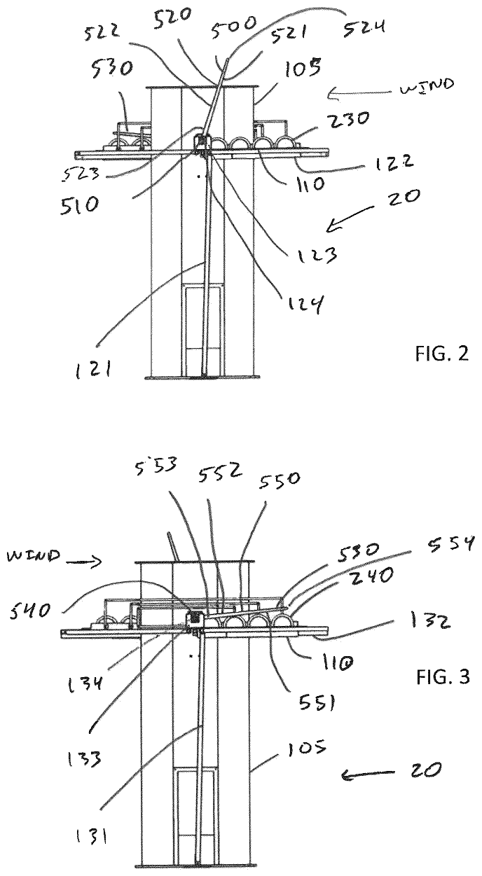

The frame 110 has a first side 120 and a second side 130. The first side 120 has a riser bar 121, a sail support 122 and an end tab 123 with a bearing hole 124 (FIG. 2). The second side 130 is similar to the first side, and has a riser bar 131, a sail support 132, and an end tab 133 with a bearing hole 134 (FIG. 3).

As seen in FIG. 5, the base 150 has two oppositely extending pivot arms 160 and 170, respectively. Pivot arm 160 has a proximal end 161 and a distal end 163. The proximal end 161 can be vertically adjusted with an adjuster 162. One preferred adjuster is a threaded bolt. The distal end 163 can be selectively raised and lowered relative to the proximal end 161. Pivot arm 170 has a proximal end 171 and a distal end 173. The proximal end 171 can be vertically adjusted with an adjuster 172. One preferred adjuster is a threaded bolt. The distal end 173 can be selectively raised and lowered relative to the proximal end 171.

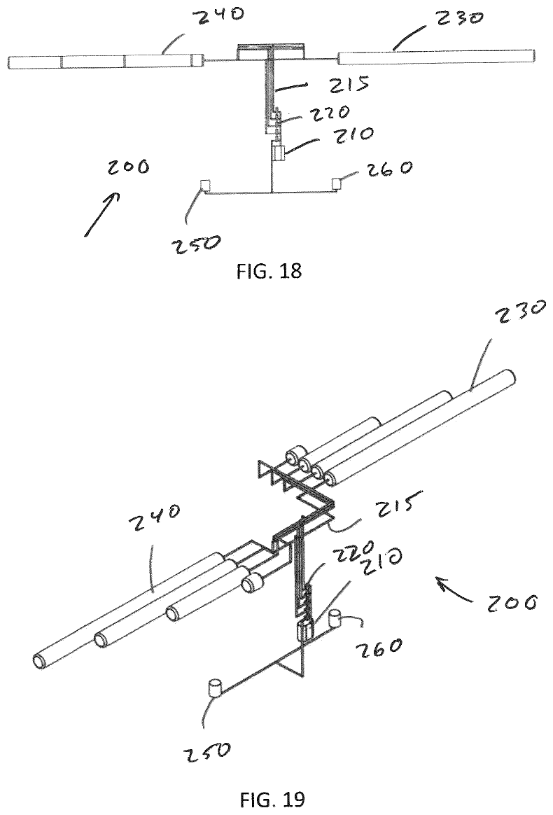

The air system 200, which is illustrated in isolation in FIGS. 18 and 19, has a compressor and tank 210, lines 215, regulators 220, dampeners 230 and 240, and base lifts 250 and 260. Each dampener 230 and 240 is preferably comprised of air bags that are supplied with pressurized air to inflate. In the preferred embodiment, each dampener has four air bags, of successively longer length to accommodate the shape of the sails which are described below. Also in the preferred embodiment, air bags of the same size and placement in the opposite dampener are paired with a shared regulator. In this regard, this allows for improved deflation of the dampener air bag when the sail impacts the respective dampener as air can flow from the impacted dampener air bag to the non-impacted dampener air bag. Further successively remote air bags (relative to the shaft assembly) on each dampener preferably have an increased air pressure. This allows the air bag closest to the shaft assembly to compress easier than the next dampener, to accommodate the impact angle of the sail. Base lift 250 lifts distal end 163 of the pivot arm 160 when the air system 200 is operational. Base lift 260 lifts distal end 173 of the pivot arm 170 when the air system 200 is operational.

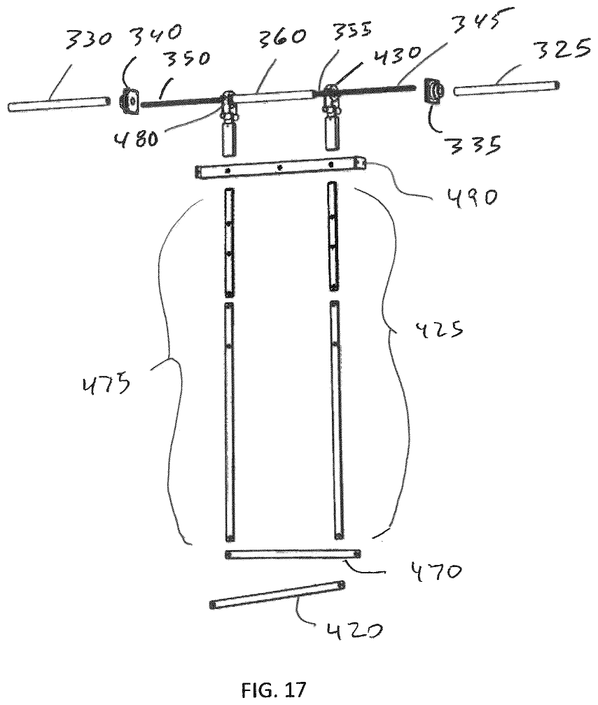

The sail assembly 300 has a positioner 310. The positioner 310 has a shaft assembly 320, a first side assembly 400 and a second side assembly 450. The positioner 310 is illustrated in an exploded view in FIG. 17 and shown assembled in several other figures.

Shaft assembly 320, as seen in FIG. 17, has two oppositely located end shafts 325 and 330, respectively, two housing bearings 335 and 340, two hex shafts 345 and 350, a spiral hex shaft 355 and a spiral hex sleeve 360.

On one side, starting from the distal end and moving inward, end shaft 325 (having a round exterior and a hex interior) is connected to the housing bearing 335. The housing bearing 335 has a collar that is fixed to the exterior of end shaft 325 on the interior end. End shaft 325 can rotate relative to the housing bearing 335. The housing bearing 335 is also connected to the housing 105. The end shaft 325 is also connected to the hex shaft 345 in a telescopic relationship. The hex shaft 345 is connected to the spiral hex shaft 355. The end shaft 325, hex shaft 345 and spiral hex shaft 355 are rotationally fixed with respect to each other.

On the other side, again when starting from the distal end and moving inwards, end shaft 330 (having a round exterior and a hex interior) is connected to the housing bearing 340. The housing bearing 340 has a collar that is fixed to the exterior end of shaft 330 on the interior end. End shaft 330 can rotate relative to the housing bearing 340. The housing bearing 340 is also connected to the housing 105. The end shaft 330 is also connected to the hex shaft 350 in a telescopic relationship. The hex shaft 350 is connected to the spiral hex sleeve 360. The end shaft 330, hex shaft 350 and spiral hex sleeve 360 are rotationally fixed with respect to each other.

The end of the spiral hex shaft 355 mates with the spiral hex sleeve 360 in a rotation to translation telescopic relationship. To accommodate the linear movement between the spiral hex shaft 355 and the spiral hex sleeve 360, the hex shafts 345 and 350 traverse the end shafts 325 and 330, respectively, in proportion to the linear distance the spiral hex shaft 335 moves relative to the spiral hex sleeve 360.

Housing bearings 335 and 340 are used to connect the positioner 310 to the housing 105 and to keep the positioner 310 centered with respect to the housing 105. The shaft assembly 320 can rotate relative to the housing bearings 335 and 340.

Side assembly 400 has a weight 410 atop a roller 415 (which can have one or more wheels or other rolling elements), a lower arm 420, an upper arm 425, and a bearing assembly 430. The lower portion of the lower arm 420 is connected to the weight 410, the upper portion of the lower arm 420 is pivotally connected to the lower portion of the upper arm 425. The upper portion of the upper arm 425 is connected to the bearing assembly 430. Preferably, the upper end of the upper arm 425 is slid into a receiver on the bottom of the bearing assembly 430. The bearing assembly has a bearing that is connected to the shaft assembly and allows the shaft assembly to rotate without interfering with the longitudinal location of the bearing assembly with respect to the shaft assembly.

Side assembly 450 has a weight 460 atop a roller 465 (which can have one or more wheels or other rolling elements), a lower arm 470, an upper arm 475, and a bearing assembly 480. The lower portion of the lower arm 470 is connected to the weight 460, the upper portion of the lower arm 470 is pivotally connected to the lower portion of the upper arm 475. The upper portion of the upper arm 475 is connected to the bearing assembly 480. Preferably, the upper end of the upper arm 475 is slid into a receiver on the bottom of the bearing assembly 480. The bearing assembly has a bearing that is connected to the shaft assembly and allows the shaft assembly to rotate without interfering with the longitudinal location of the bearing assembly with respect to the shaft assembly. Upper arms 425 and 475 are offset from one another to allow for passage next to each other.

Side assembly 400 is pivotally connected to one end of bar 490, and side assembly 450 is pivotally connected to the other end of bar 490. Bearing assemblies 430 and 480 and longitudinally fixedly connected to the shaft assembly 320. Stated another way, the bearing assemblies maintain their point of engagement with respect to the shaft assembly, even as the shaft assembly rotates, and the bearing assemblies move farther away from and closer to each other.

Sail 500 has a shaft 510 and body 520. The body has a lower face 521 and an upper face 522. Face 521 faces the dampener 230. Face 522 is oriented upwards. Sail has a proximal edge 523 adjacent to the shaft 510 and a distal edge 524. Sail shaft 510 is supported by the end shaft 325 and by the end tab 123 of the first side 120 of the frame 110, and is rotatable within the bearing hole 124 of the end tab 123.

Sail 530 has a shaft 540 and body 550. The body has a lower face 551 and an upper face 552. Face 551 faces the dampener 240. Face 552 is oriented upwards. Sail has a proximal edge 553 adjacent to the shaft 550 and a distal edge 554. Sail shaft 540 is supported by the end shaft 330 and by the end tab 133 of the second side 130 of the frame 110 and is rotatable within bearing hole 134 of end tab 133.

Sails 500 and 530 are rotationally fixed to the respective end shafts 320 and 325, wherein sails pivot at the same time relative to each other and in proportion to each other.

The turbine 20 can be operated when the air system 200 is functioning properly. The functioning air system 200 inflates base lift 250 to lift the distal end 163 of pivot arm 160. The air system 200 also inflates base lift 260 to lift the distal end 173 of pivot arm 170. In this position the weights 410 and 460 are at their innermost positions, as seen in FIGS. 4 and 5. Looking at FIG. 7, the upper arms 425 and 475 are closest together, so that the spiral hex shaft 355 is in the fully received position within the spiral hex sleeve 360. In this position, the sails are preferably about 95 degrees angularly offset in the fully open state.

Wind moves the turbine 20 about a vertical axis as it engages whichever lower face 521 or 551 that faces the wind. The wind lifts the lower face of the sail facing the wind as it pushes down against the upper face of the opposite sail. The sails alternate between thrust and closed positions as the turbine rotates.

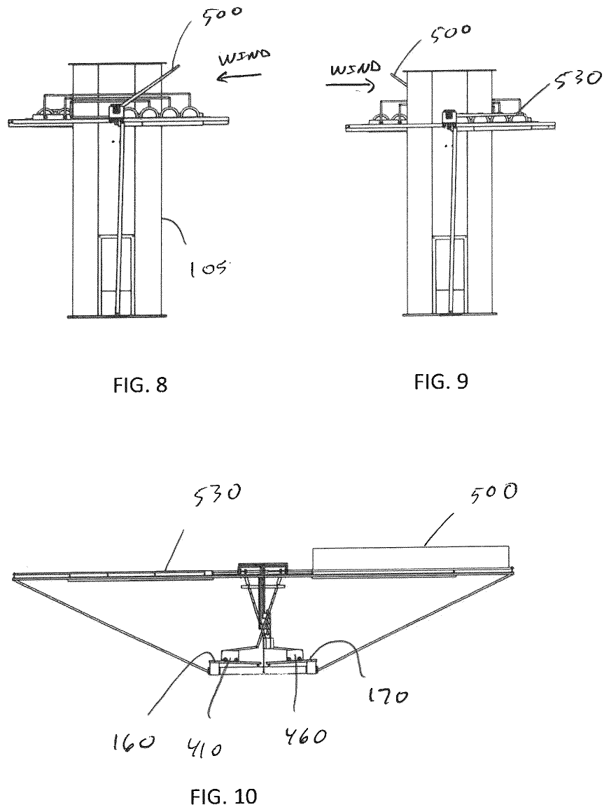

As the turbine 20 picks up rotational speed, the weights 410 and 460 may roll outwards and up respective pivot arms by amounts in proportion to the centrifugal forces. The angles of the pivot arms can be fine-tuned with adjusters 162 and 172, as the pitch of the pivot arms dictates the rotational speed required to force the weights up the angled pivot arms. An intermediate position is illustrated in FIGS. 8-11. In this position, the sails are partially closed to reduce the rotational speed of the turbine 20. As the weights move outwards, the upper ends of arms 425 and 475 separate, causing the spiral hex shaft 355 to partially move out of the spiral hex sleeve 360, causing the end shafts 325 and 330 to be rotated to a different rotational orientation. The intermediate orientation is anywhere between fully open (95 degrees separation) and fully closed (180 degrees separation).

The sails 500 and 530 can be closed due to exceeding a maximum turbine rotational speed, as seen in FIGS. 12-14. In this closed-speed state, the weights are all the way out, causing maximum separation of the upper ends of arms 425 and 475, causing the spiral hex shaft 355 to move out of the spiral hex sleeve 360 by its maximum amount, causing the sails to be closed.

The air bags dampen the impact of the sails moving to the closed position. Sails 500 and 530 can also close if there is a default in the air system 200. In a default state, the base lifts 250 and 260 deflate so that the pivot arms 160 and 170 are angled downward from the turbine center allowing the weight to roll to the outward position. The turbine 20 can be restarted by repressurizing the system (after repairs). This can be done without electricity by bringing a source of compressed air.

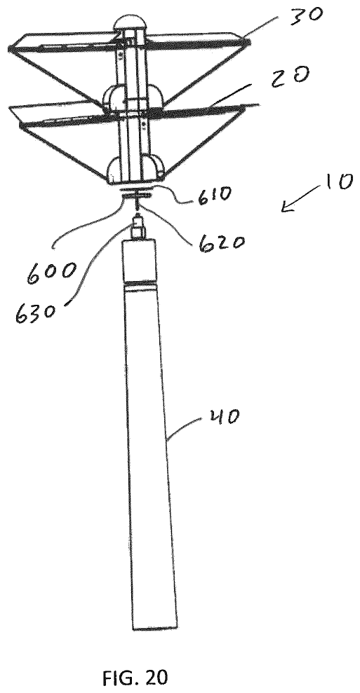

Turning now to FIGS. 20-23, it is seen how a turbine 20 is connected to a tower 40. This is preferably accomplished with the use of a turret 600, a shaft plate 610 with a vertical shaft 620 and a generator 630. In this regard the shaft plate 610 is fixed to the bottom of the turbine 20, wherein rotation of the turbine 20 also rotates the vertical shaft 620. The vertical shaft 620 is connected to the generator to generate electricity from being rotated via the wind energy. The turret 600 allows the turbine 20 to rotate while being safely connected to the top of the tower 40.

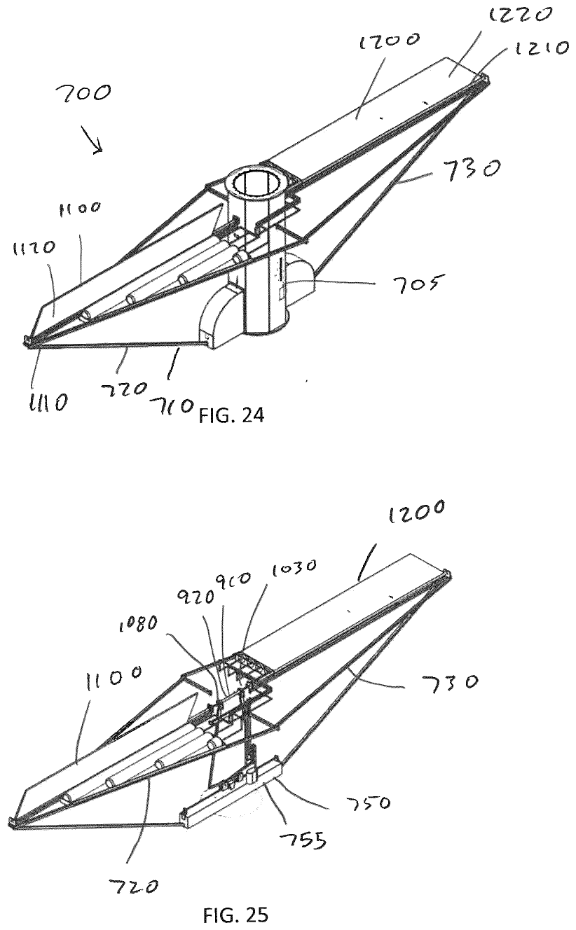

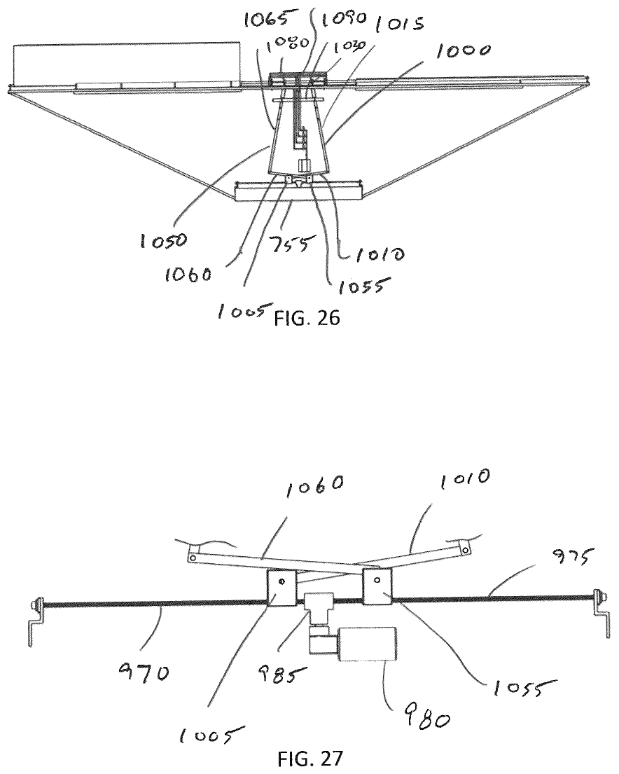

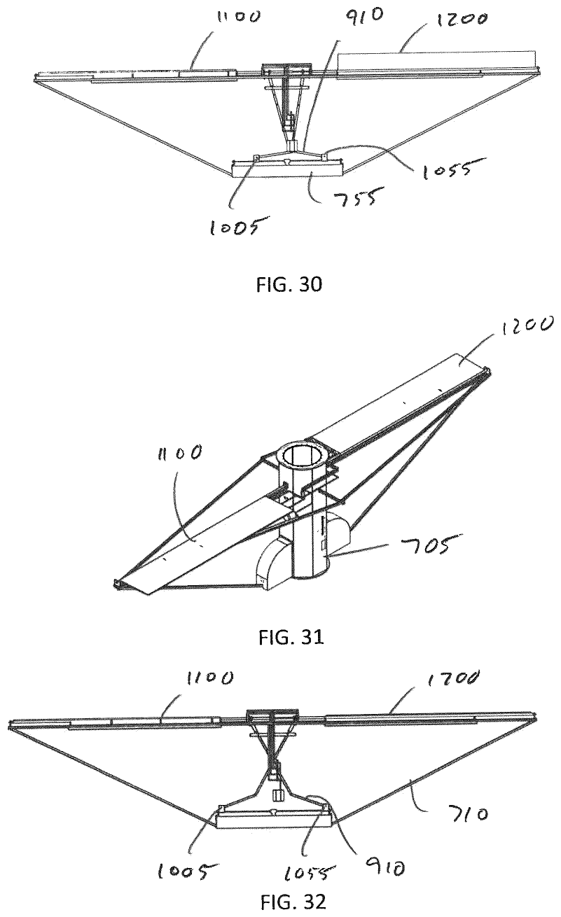

Turning now to FIGS. 24-34, it is seen that an alternative embodiment of a turbine 700 is illustrated. Turbine 700 has a housing 705, a frame 710 with a base 750, an air system 800 and a sail assembly 900. The sail assembly 900 has a positioner 910, a first sail 1100 and a second sail 1200. Each of these components are described below.

The housing 705 covers the base 750. The frame 710 has a first side 720 and a second side 730. Frame sides 720 and 730 are similar to frame sides 120 and 130. Base 750, however, is different and comprises a beam 755.

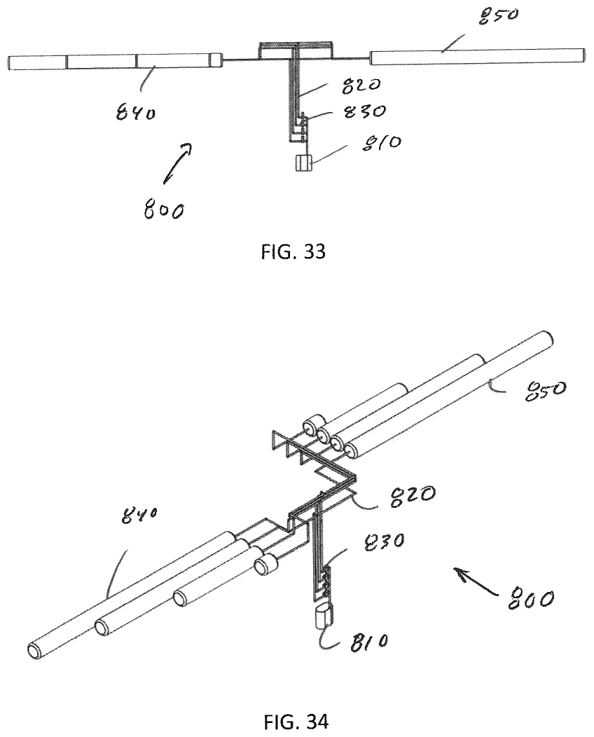

The air system 800, which is illustrated in isolation in FIGS. 33 and 34, has a compressor and tank 810, lines 820, regulators 830, and dampeners 840 and 850. Each dampener 840 and 850 is preferably comprised of air bags that are supplied with pressurized air to inflate. In the preferred embodiment, each dampener has four air bags, of successively longer length to accommodate the shape of the sails which are described below. Also in the preferred embodiment, air bags of the same size and placement in the opposite dampener are paired with a shared regulator. In this regard, this allows for improved deflation of the dampener air bag when the sail impacts the respective dampener as air can flow from the impacted dampener air bag to the non-impacted dampener air bag. Further successively remote air bags (relative to the shaft assembly) on each dampener preferably have an increased air pressure. This allows the air bag closest to the shaft assembly to compress easier than the next dampener, to accommodate the impact angle of the sail.

The sail assembly 900 has a positioner 910. The positioner 910 has a shaft assembly 920, a lower assembly 965, a first side assembly 1000 and a second side assembly 1050.

Shaft assembly 920, is similar to shaft assembly 320 and preferably has the same parts wherein an end of the spiral hex shaft mates with a spiral hex sleeve in a translation to rotation relationship.

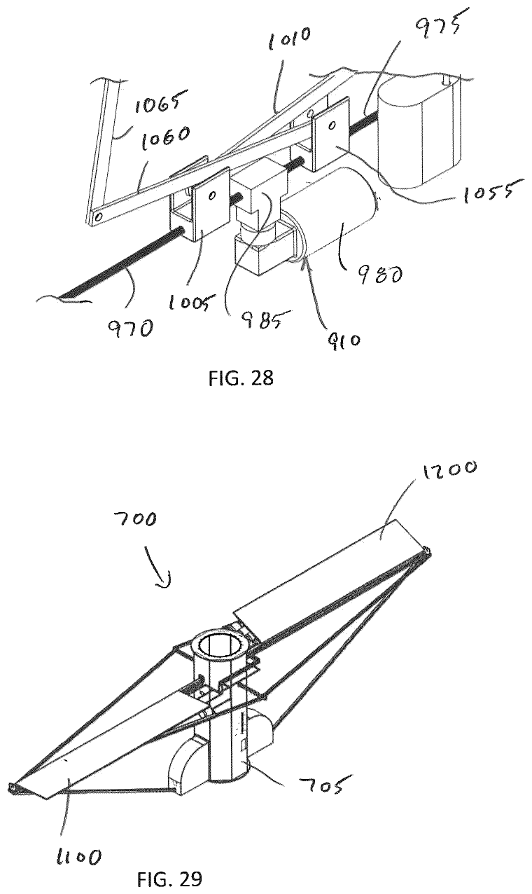

Lower assembly 965, as seen in FIGS. 27 and 28, has a first side shaft 970, a second side shaft 975, a gear motor 980 and a counter rotating gear box 985. Side shafts 970 and 975 are threaded. In the preferred embodiment, both side shafts 970 and 975 are threaded with right-hand threads. Gear motor 980 can cause the counter rotating gear box 985 to spin the shafts in opposite rotational directions. Items threadably connected to the shafts 970 and 975 will simultaneously move either towards or away from the gearbox 985 as the shafts 970 and 975 rotate.

Side assembly 1000 has a threaded block 1005, a lower arm 1010, an upper arm 1015, and a bearing assembly 1030. Threaded block 1005 is threadably connected to shaft 970. Lower arm 1010 is pivotally connected to threaded block 1005, upper arm 1015 and lower arm 1010 are pivotally connected, and the upper portion of upper arm 1015 is pivotally connected to the bearing assembly 1030. The bearing assembly is connected to a fixed point on the shaft assembly 920. The bearing assembly allows the shaft assembly to rotate without interfering with the longitudinal location of the bearing assembly with respect to the shaft assembly.

Side assembly 1050 has a threaded block 1055, a lower arm 1060, an upper arm 1065, and a bearing assembly 1080. Threaded block 1055 is threadably connected to shaft 975. Lower arm 1060 is pivotally connected to threaded block 1055, upper arm 1065 and lower arm 1060 are pivotally connected, and the upper portion of upper arm 1065 is pivotally connected to the bearing assembly 1080. The bearing assembly is connected to a fixed point on the shaft assembly 920. The bearing assembly allows the shaft assembly to rotate without interfering with the longitudinal location of the bearing assembly with respect to the shaft assembly.

Side assembly 1000 is pivotally connected to one end of bar 1090, and side assembly 1050 is pivotally connected to the other end of bar 1090. Bearing assemblies 1030 and 1080 are longitudinally fixedly connected to the shaft assembly 920. Stated another way, the bearing assemblies maintain their point of engagement with respect to the shaft assembly, even as the shaft assembly rotates and the bearing assemblies move farther away from and closer to each other.

Sail 1100 has a shaft 1110 and body 1120 and is preferably similar to sail 500 in composition and operation.

Sail 1200 has a shaft 1210 and body 1220 and is preferably similar to sail 530 in composition and operation.

The gear motor 980 adjusts the angular offset of the sails (between 95 degrees at full open state to 180 degrees at fully closed state) to prevent the turbine from spinning too fast. As the turbine picks up speed, the gear motor 980 drives the gearbox 985 to rotate shafts 970 and 975 causing the threaded blocks 1005 and 1055 to move away from the gearbox.

As with turbine 20, this causes the bearing assemblies 1030 and 1080 to separate and cause the spiral hex shaft to translate out of the spiral hex sleeve thereby changing the angle between the sails 1100 and 1200.

The opposite occurs to increase the angle of the sail to capture a greater amount of wind energy.

In this embodiment, it is preferred that whenever a default is present in the air system 800, that the gearmotor 980 operates to move the sails 1100 and 1200 to closed positions.

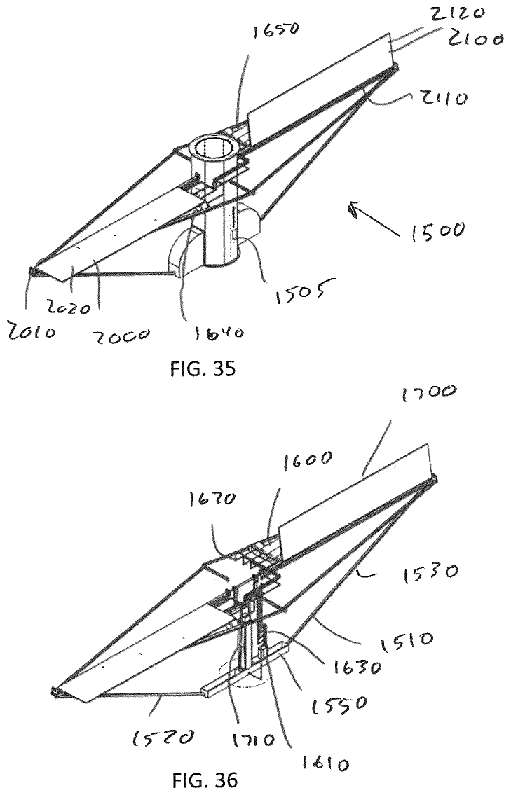

Turning now to FIGS. 35-42, it is seen that an alternative embodiment of a turbine 1500 is illustrated. Turbine 1500 has a housing 1505, a frame 1510 with a base 1550, an air system 1600 and a sail assembly 1700. The sail assembly 1700 has a positioner 1710, a first sail 2000 and a second sail 2100. The turbine 1500 further has a brake assembly 2200. Each of these components are described below.

The housing 1505 covers the base 1550. The frame 1510 has a first side 1520 and a second side 1530. Frame sides 1520 and 1530 are similar to frame sides 120 and 130. Base 1550 comprises a beam.

The air system 1600 has a compressor and tank 1610, lines 1620, regulators 1630, and dampeners 1640 and 1650. Each dampener 1640 and 1650 is preferably comprised of air bags that are supplied with pressurized air to inflate. In the preferred embodiment, each dampener has four air bags, of successively longer length to accommodate the shape of the sails which are described below. Also in the preferred embodiment, air bags of the same size and placement in the opposite dampener are paired with a shared regulator. In this regard, this allows for improved deflation of the dampener air bag when the sail impacts the respective dampener as air can flow from the impacted dampener air bag to the non-impacted dampener air bag. Further successively remote air bags (relative to the shaft assembly) on each dampener preferably have an increased air pressure. This allows the air bag closest to the shaft assembly to compress easier than the next dampener, to accommodate the impact angle of the sail.

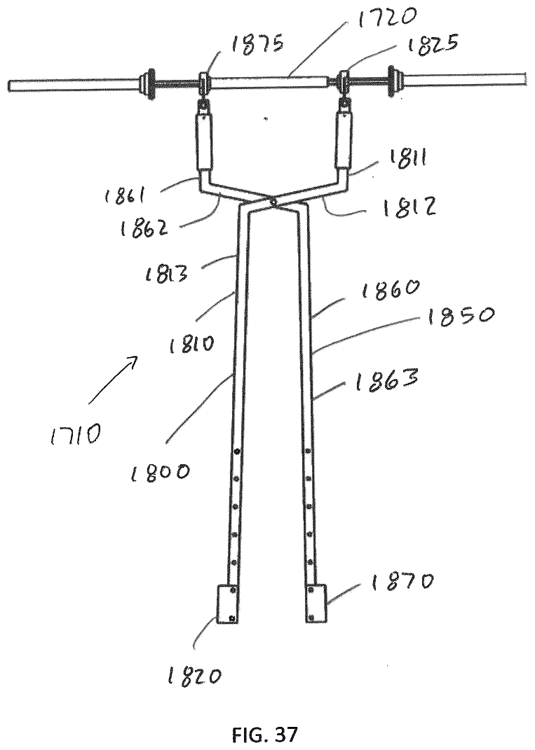

The sail assembly 1700 has a positioner 1710, as seen in isolation in FIG. 37. The positioner 1710 has a shaft assembly 1720, a first side assembly 1800 and a second side assembly 1850.

Shaft assembly 1720, is similar to shaft assembly 320 and preferably has the same parts wherein an end of the spiral hex shaft mates with a spiral hex sleeve in a translation to rotation relationship.

Side assembly 1800 has an arm 1810 with an upper portion 1811, a middle portion 1812 and a lower portion 1813. A weight 1820 is attached to the lower portion 1813. The upper portion is pivotally connected to a bearing assembly 1825. The bearing assembly is connected to a fixed point on the shaft assembly 1720. The bearing assembly allows the shaft assembly to rotate without interfering with the longitudinal location of the bearing assembly with respect to the shaft assembly.

Side assembly 1850 has an arm 1860 with an upper portion 1861, a middle portion 1862 and a lower portion 1863. A weight 1870 is attached to the lower portion 1863. The upper portion is pivotally connected to a bearing assembly 1875. The bearing assembly is connected to a fixed point on the shaft assembly 1720. The bearing assembly allows the shaft assembly to rotate without interfering with the longitudinal location of the bearing assembly with respect to the shaft assembly.

The middle portion 1812 of arm 1810 is pivotally connected to the middle portion 1862 of arm 1860.

Sail 2000 has a shaft 2010 and body 2020 and is preferably similar to sail 500 in composition and operation.

Sail 2100 has a shaft 2110 and body 2120 and is preferably similar to sail 530 in composition and operation.

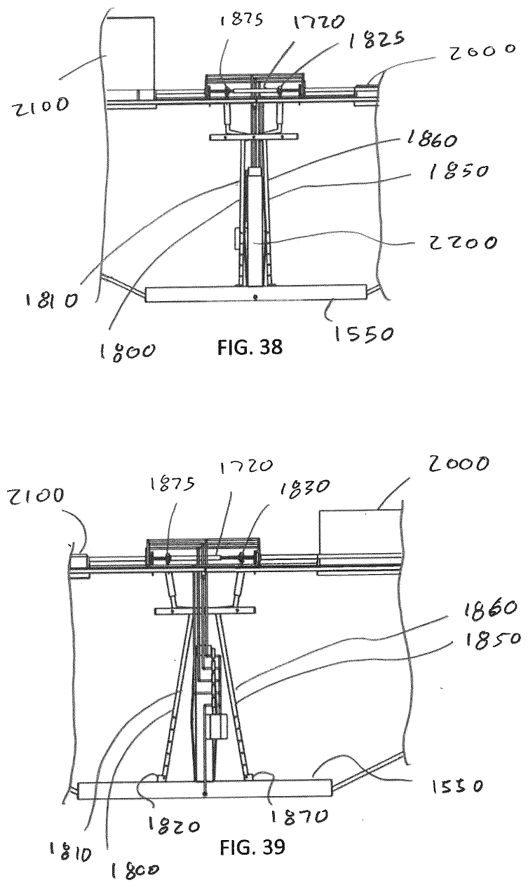

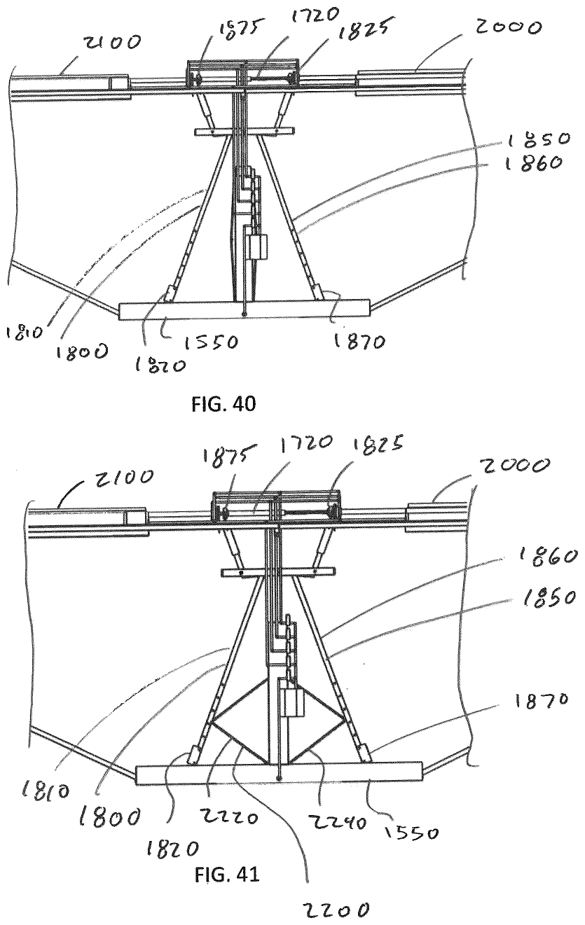

In operation, as turbine 1500 increases in rotational speed, the weights 1820 and 1870 spread as the rotational forces exceed the force of gravity as the weights are a governor. As the weights spread (example, FIG. 39), bearing assemblies 1825 and 1875 also spread to alter the angular position of the sails 2000 and 2100. The faster the turbine 1500 spins, the closer the sails 2000 and 2100 are adjusted to be separated by 180 degrees. In FIG. 40, the sails are fully closed due to speed. As the rotational speed slows and the weights fall under force of gravity, the sails can move back towards and ultimately to the fully open position being separated by 95 degrees (FIG. 38).

The air system 1600 has an air ram 1660 that is extended when the air system 1600 is operating.

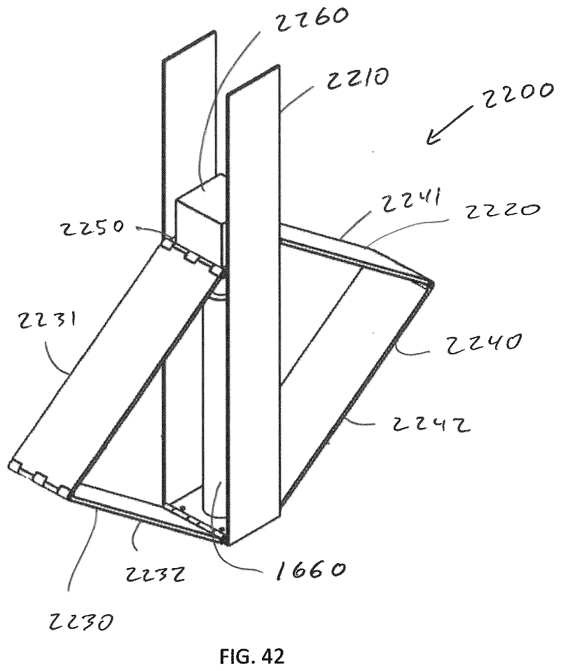

A brake assembly 2200 is provided and is best illustrated in FIGS. 41 and 42. The brake system 2200 has a bracket 2210 supporting a scissor 2220 having two sides 2230 and 2240. Side 2230 has two pieces 2231 and 2232 that are pivotally connected to each other. Side 2240 has two pieces 2241 and 2242 that are pivotally connected to each other. The second pieces 2232 and 2242 are lower pieces and are pivotally connected to the bottom of the bracket 2210. The first pieces 2231 and 2241 are upper pieces and are pivotally connected to a top plate 2250 having an upper surface and a lower surface. A weight 2260 rests on the upper surface of the top plate 2250.

The air ram 1660 engages the bottom surface of the top plate 2250 when the air system operates to hold the scissor 2220 in an open position where the sides 2230 and 2240 are nearly parallel to each other. In the event of an air failure, the ram 1660 lowers under force of the weight, pushing sides 2230 and 2240 (specifically the point where the first and second pieces are pivotally connected) laterally outwards against the arms 1810 and 1860 so that the lower portions of the arms separate to move the sails to the closed position. In this regard, it is understood that the weight of weight 2260 is sufficient to displace and lift weights 1820 and 1870.

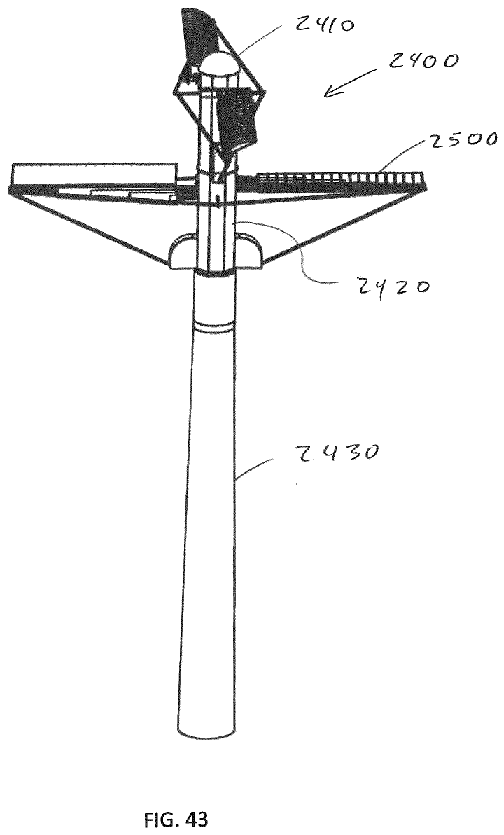

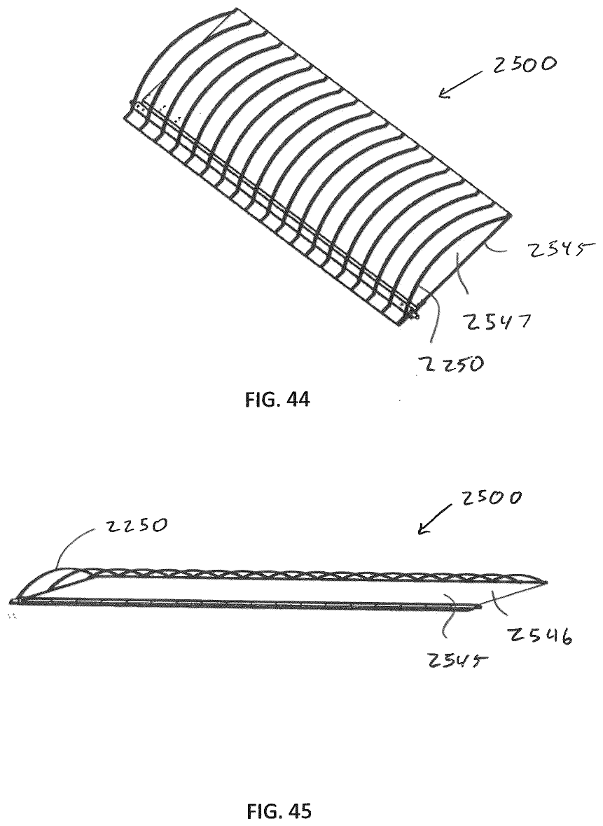

Turning now to FIGS. 43-45, it is seen that another embodiment of a windmill 2400 is illustrated. The windmill 2400 has turbines 2410 and 2420, and a tower 2430. Each turbine has improved sails 2500. Each sail 2500 has a body 2545 with two faces, a lower face 2546 and an upper face 2547. The upper face 2547 has a plurality of springs 2250 attached thereto. The springs are preferably arcuate shaped and provide strength and ability to absorb additional forces as the sails move to closed position, as well as absorb additional stress caused by the force of the wind.

It is appreciated the present invention can be sized for many applications, including but not limited to portable windmills, household windmills and commercial windmills (ranging from a few feet or even less in size to several hundred or more feet in size). It is also appreciated that the amount of the weights and size of the sails can vary. In a preferred embodiment, one rotation of the sails about a vertical axis can be accomplished in about 10 seconds during operation (sails flip every five seconds). The intended operational revolutions per minute can be increased or decreased without departing from the broad aspects of the present invention. In this scenario where a revolution occurs in 10 seconds during operation, by way of illustration, the sails could start to close if the rotation occurs in about 8 seconds as the positioners close the sails.

Hence, it is seen that a novel windmill has been provided according to the present invention, including a turbine comprising:
a housing;
a frame; and
a sail assembly, the sail assembly comprising:
   a positioner comprising a shaft assembly, the shaft assembly having a first end and a second end, the first end being selectably rotatable relative to the second end;
   a first sail at the first end; and
   a second sail at the second end, said second sail being angularly offset from said first sail by an angle,
wherein rotation of the first end relative to the second end adjusts the angle between the first sail and the second sail.

It is appreciated that the turbine can be further defined in many different ways as described above and in the claims.

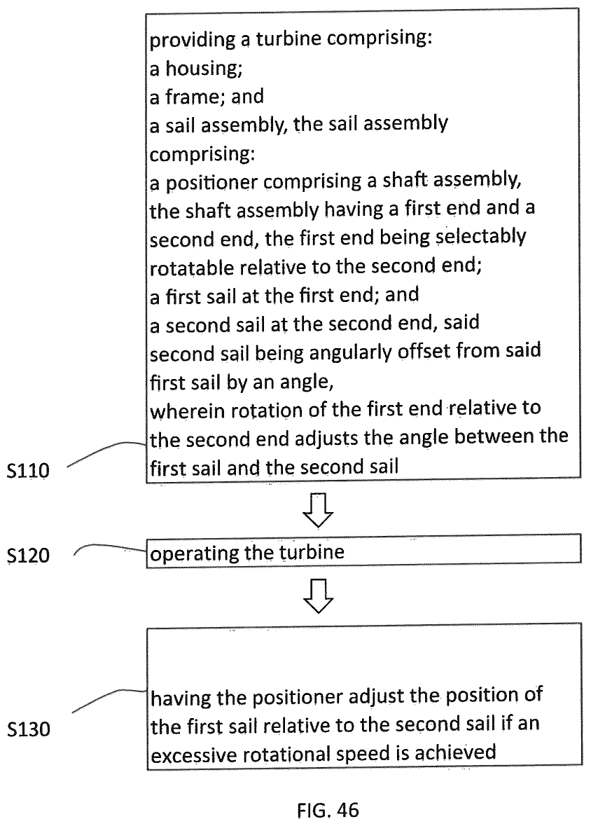

It is also understood that a novel method of operating a turbine is provided in FIG. 46, and comprises the steps:
(Step 110) providing a turbine comprising:
a housing;
a frame; and
a sail assembly, the sail assembly comprising:
   a positioner comprising a shaft assembly, the shaft assembly having a first end and a second end, the first end being selectably rotatable relative to the second end;
   a first sail at the first end; and
   a second sail at the second end, said second sail being angularly offset from said first sail by an angle,
wherein rotation of the first end relative to the second end adjusts the angle between the first sail and the second sail;
(Step 120) operating the turbine; and
(Step 130) having the positioner adjust the position of the first sail relative to the second sail if an excessive rotational speed is achieved.

It is understood that this method can be amended or added to as described above.

Thus, it is apparent that there has been provided, in accordance with the invention, a wind turbine that fully satisfies the objects, aims and advantages as set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

1. A turbine for a windmill, the turbine comprising:
a housing;
a frame; and
a sail assembly, the sail assembly comprising:
a positioner comprising a shaft assembly, the shaft assembly having a first end and a second end, the first end being selectably rotatable relative to the second end;
a first sail at the first end; and
a second sail at the second end, said second sail being angularly offset from said first sail by an angle,
wherein rotation of the first end relative to the second end adjusts the angle between the first sail and the second sail.

2. The turbine of claim 1 wherein the shaft assembly comprises a spiral hex shaft and a spiral hex sleeve, the spiral hex shaft rotating as the spiral hex shaft moves relative to the spiral hex sleeve relative to a shaft assembly longitudinal axis.

3. The turbine of claim 2 wherein:
the shaft assembly further comprises:
a first end shaft;
a first hex shaft in a telescopic relationship with said first end shaft, said first hex shaft being connected to said spiral hex shaft;
a second end shaft; and
a second hex shaft in a telescopic relationship with said second end shaft, said second hex shaft being connected to said spiral hex sleeve;
the first sail is supported by the first end shaft; and
the second sail is supported by the second end shaft.

4. The turbine of claim 3 wherein the shaft assembly further comprises:
a first housing bearing connected to the first end shaft and to the housing; and
a second housing bearing connected to the second end shaft and to the housing.

5. The turbine of claim 1 further comprising an air system, the air system comprising a first dampener operable with the first sail and a second dampener operable with the second sail.

6. The turbine of claim 1 wherein the positioner further comprises:
a first side assembly with a first side assembly weight; and
a second side assembly with a second side assembly weight.

7. The turbine of claim 6 wherein, when the turbine achieved an excessive rotational speed, the first side assembly weight and the second side assembly weight move out from a central axis to adjust the position of the first end relative to the second end.

8. The turbine of claim 7 wherein:
the turbine further comprises a base, the base comprising:
a first pivot arm with a first pivot arm proximal end and a first pivot arm distal end; and
a second pivot arm with a second pivot arm proximal end and a second pivot arm distal end; and
the first side assembly further comprises a first side assembly roller that supports the first side assembly weight, the first side assembly roller moving towards first pivot arm distal end if the excess rotational speed is achieved; and
the second side assembly further comprises a second side assembly roller that supports the second side assembly weight, the second side assembly roller moving towards the second pivot arm distal end if the excessive rotational speed is achieved.

9. The turbine of claim 8 further comprising an air system, said air system comprising:
a first dampener to dampen the first sail;
a second dampener to dampen the second sail;
a first base lift to lift the first pivot arm distal end; and
a second base lift to lift the second pivot arm distal end,
wherein if there the air system defaults, the first base lift lowers the first pivot arm distal end below the first pivot arm proximal end and the second base lift lowers the second pivot arm distal end below the second pivot arm proximal end.

10. The turbine of claim 6 further comprising:
an air system, said air system comprising:
a first dampener to dampen the first sail;
a second dampener to dampen the second sail; and
an air ram; and
a brake assembly, said brake assembly being operable if the air ram deflates.

11. The turbine of claim 10 wherein the brake assembly comprises a scissor with a first side and a second side, the first side operating against the first side assembly and the second side operating against the second side assembly when the air ram deflates.

12. The turbine of claim 1 wherein the positioner further comprises:
a gear motor:
a counter-rotating gear box
a first side assembly with a first side assembly threaded block;
a second side assembly with a second side assembly threaded block;
a lower assembly first side shaft operable with the first side assembly threaded block; and
a lower assembly second side shaft operable with the second side assembly threaded block,
wherein the counter-rotating gear box causes the first side assembly threaded block and the second side assembly threaded block to selectively move towards and away from the counter-rotating gear box in unison.

13. The turbine of claim 1 wherein the angle is between 85 and 180 degrees.

14. The turbine of claim 1 wherein the first sail comprises an upper face, a lower face and a plurality of springs on the upper face.

15. A method of operating a turbine of a windmill comprising the steps:
providing a turbine comprising:
a housing;
a frame; and
a sail assembly, the sail assembly comprising:
a positioner comprising a shaft assembly, the shaft assembly having a first end and a second end, the first end being selectably rotatable relative to the second end;
a first sail at the first end; and
a second sail at the second end, said second sail being angularly offset from said first sail by an angle,
wherein rotation of the first end relative to the second end adjusts the angle between the first sail and the second sail;
operating the turbine; and
having the positioner adjust the position of the first sail relative to the second sail if an excessive rotational speed is achieved.

16. A turbine for a windmill, the turbine comprising:
a housing;
a frame;
a base;
an air system; and
a sail assembly, the sail assembly comprising:
a positioner with a shaft assembly, the shaft assembly having a first end and a second end;
a first sail at the first end; and
a second sail at the second end.

17. A turbine for a windmill, the turbine comprising:
a housing;
a frame;
a base; and
a sail assembly, the sail assembly comprising:
a positioner comprising:
a shaft assembly, the shaft assembly having a first end and a second end, the first end being selectably rotatable relative to the second end to a rotational orientation;
a first side assembly with a first weight;
a second side assembly with a second weight;
a first sail at the first end; and
a second sail at the second end
wherein the first weight and the second weight move away from a turbine center upon the turbine exceeding a threshold rotational speed, the movement of the weights determine the rotational orientation.

18. The turbine of claim 17 wherein:
the first weight is on a first roller that rolls up a first pivot arm in proportion to the rotational speed; and
the second weight is on a second roller that rolls up a second pivot arm in proportion to the rotational speed.

19. The turbine of claim 17 further comprising an air system.

20. The turbine of claim 19 wherein the air system comprises a first base lift and a second base lift, the first base lift and the second base lift lowering if there is an air system failure.

21. The turbine of claim 20 wherein:
the air system comprises an air ram, the air ram lowering if there is an air system failure; and
lowering of the air ram allows a brake assembly to activate.

22. A turbine for a windmill, the turbine comprising:
a housing;
a frame;
a base; and
a sail assembly, the sail assembly comprising:
a lower assembly supported by the base and comprising a first side shaft, a second side shaft, a gear motor and a counter rotating bear box, said first side shaft and second side shaft being rotatable in opposite rotational directions by said counter rotating gear box;
a positioner comprising:
a shaft assembly, the shaft assembly having a first end and a second end, the first end being selectably rotatable relative to the second end to a rotational orientation;
a first side assembly with a first block;
a second side assembly with a second block;
a first sail at the first end; and
a second sail at the second end
wherein:
the first block is threadably connected to the first side shaft;
the second block is threadably connected to the second side shaft;
rotation of the gear motor determines the rotational orientation via movement of said first side assembly and the second side assembly.

23. A turbine for a windmill, the turbine comprising:
a housing;
a frame;
a base; and
a sail assembly, the sail assembly comprising:
a positioner with a shaft assembly, the shaft assembly having a first end and a second end, the first end being selectably rotatable relative to the second end;
a first sail at the first end, the first sail having a first sail lower face, a first sail upper face and a plurality of first sail springs on said first sail upper face; and
a second sail at the second end, the second sail having a second sail lower face, a second sail upper face and a plurality of second sail springs on said second sail upper face.
